(19) United States
(12) Patent Application Publication
(10) Pub. No.: US 2024/0118305 A1
(43) Pub. Date: Apr. 11, 2024

(54) SYSTEM AND METHOD OF ESTIMATING VEHICLE SPEED

(71) Applicant: Faraday&Future Inc., Gardena, CA (US)

(72) Inventors: Saleh Ziaieinejad, Irvine, CA (US); Geng Niu, Irvine, CA (US)

(21) Appl. No.: 18/376,792

(22) Filed: Oct. 4, 2023

Related U.S. Application Data
(60) Provisional application No. 63/413,159, filed on Oct. 4, 2022.

(51) Int. Cl. G01P 7/00; G07C 5/02

(52) U.S. Cl. CPC G01P 7/00; G07C 5/02

(57) ABSTRACT

A method to estimate the longitudinal vehicle speed is disclosed. The method can be digitally implemented to process speeds of all wheels and longitudinal acceleration of the vehicle to estimate the vehicle speed.

### CROSS-REFERENCE

This application claims the priority of provisional application no. 63/413,159, filed on Oct. 4, 2022, the content of which is incorporated by reference herein in its entirety for all purposes.

### FIELD

This application relates to estimating vehicle speed and, in particular, to a method of estimating vehicle speed using variables of wheels, traction motor(s), and service brakes.

### BACKGROUND

In normal driving conditions with good traction, vehicle speed can be estimated by (a) processing the rotating wheel speed(s) and considering the dimension(s) of the wheel(s); and/or (b) processing the rotating speed(s) of traction motor(s) and considering the gear ratio(s) and dimension(s) of the wheels. With poor traction, however, estimation of vehicle speed is very challenging. Whenever a vehicle drives on low-traction surfaces and/or the vehicle applies large torque to the wheels, one or multiple (possibly all) wheels will lose traction and could rotate freely (wheel slip). In this case, the speed of the motor(s) or wheel(s) may not represent the vehicle speed. To better estimate the vehicle speed in two-wheel-drive vehicles, commonly speed of non-driven wheels is used. All-wheel-drive vehicles, however, do not have non-driven wheels and speed estimation during wheel slip is challenging.

### SUMMARY

Embodiments of this disclosure relate to a method of estimating the longitudinal speed of a vehicle. It can be digitally implemented to process speeds of all wheels and longitudinal acceleration of the vehicle to estimate the vehicle speed. Embodiments of this method can be used in all vehicles regardless of their powertrain architecture (e.g., internal combustion engine vehicles, hybrid or plugin hybrid vehicles, electric vehicles, or fuel-cell vehicles). This method does not require any input such as signals from an IMU. Therefore, it can be referred to as an IMU-sensorless method of estimating vehicle speed.

### BRIEF DESCRIPTION OF THE DRAWINGS

FIG. 1 illustrates the exemplary modules of a system for estimating vehicle speed, according to an embodiment of the disclosure.

FIG. 2a illustrates the operations of the first subsystem of the system of FIG. 1, according to an embodiment of the disclosure.

FIG. 2b illustrates the exemplary modules of the first subsystem of FIG. 2a, according to an embodiment of the disclosure.

FIG. 3 illustrates the exemplary modules of the second subsystem of the system of FIG. 1, according to an embodiment of the disclosure.

FIG. 4 is a diagram illustrating the exemplary operations of one of the modules of the second subsystem, according to an embodiment of the disclosure.

FIG. 5 is a diagram illustrating the operations of another module of the second subsystem, according to an embodiment of the disclosure.

FIG. 6 illustrates the exemplary operations performed by the third subsystem of the system of FIG. 1, according to an embodiment of the disclosure.

FIG. 7 illustrates the exemplary operations of the fourth subsystem of the system of FIG. 1, according to an embodiment of the disclosure.

FIG. 8 illustrates an alternative embodiment to the fourth subsystem of the system of FIG. 1, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

Embodiments of the disclosed method are for the case that the vehicle is not equipped with an IMU (or the use of IMU data for speed estimation is not desirable).

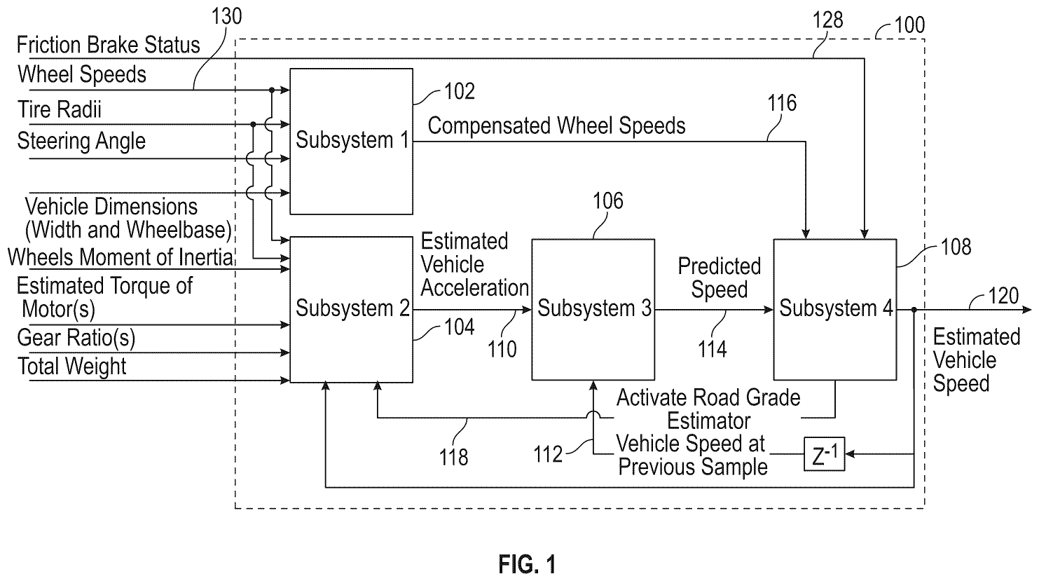

FIG. 1 illustrates the exemplary modules of system 100, according to an embodiment of the disclosure. System 100 of FIG. 1 includes 4 subsystems 102, 104, 106, 108, each of which will be discussed in detail below.

### First Subsystem 102

The first subsystem 102 processes wheel speeds 130 and outputs compensated wheel speeds 116. It should be noted that, with the assumption of ideal traction, when the vehicle moves in a straight line, linear speed of each wheel equals the longitudinal vehicle speed. However, when the vehicle is turning, none of the wheel speeds represent the longitudinal vehicle speeds. The first subsystem 102 can find gain factors to be multiplied by the rotating wheel speeds such that each rotating wheel speed equals the longitudinal speed of the vehicle. In this embodiment, we consider the following two assumptions.

First, for simplicity, longitudinal vehicle speed is calculated for the point at the middle of the assumptive line connecting the centers of the rear wheels. This method could be modified to consider other points including the center of gravity of the vehicle. Second, for simplicity, instead of considering the exact angles of left and right front wheels, the average of the two is considered.

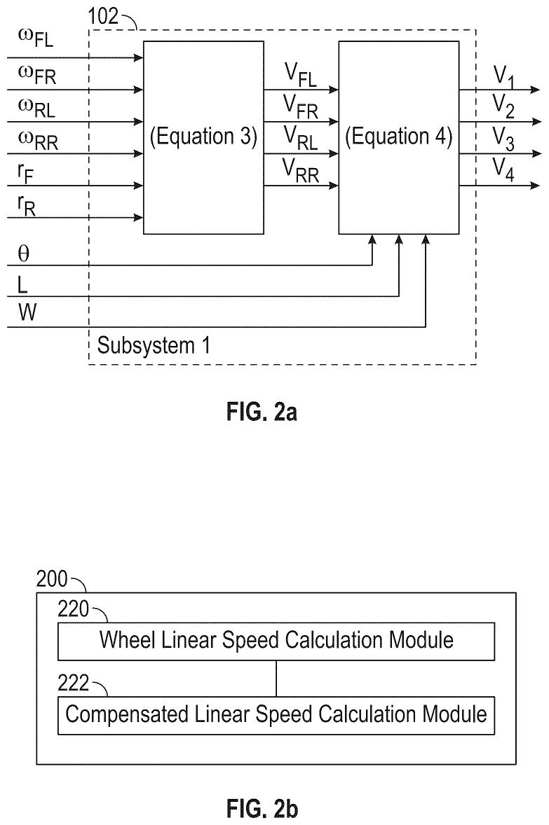

FIG. 2a illustrates the operations of the first subsystem 102, according to an embodiment of the disclosure. First, rotating wheel speeds (collectively 230) are multiplied by tire radii (collectively 240) to calculate linear speed of each wheel (collectively 250):

V_{FL}=r_{F}ω_{FL}

V_{FR}=r_{F}ω_{FR}

V_{RL}=r_{R}ω_{RL}

V_{RR}=r_{R}ω_{RR} (Equation 1)

In this equation, ωᵢ is the rotating speed of wheel i, Vᵢ is the linear speed of wheel i, r_{F} is the radius of front tires, and r_{R} is the radius of rear tires.

Based on Ackerman steering geometry and considering the abovementioned assumptions, compensated linear speed measured from each wheel is calculated as:

$${V}_{1} ≃ \{ \begin{matrix}( 1 + \frac{W tan θ}{2 L} ) {V}_{RL} , & θ \geq 0 ( turning left ) ; \\ ( 1 + \frac{W tan θ}{2 L - 2 W tan θ} ) {V}_{RL} , & θ < 0 ( turning right ) .\end{matrix} \qquad ( Equation 2 )$$

$${V}_{2} ≃ \{ \begin{matrix}( 1 - \frac{W tan θ}{2 L + 2 W tan θ} ) {V}_{RR} , & θ \geq 0 ( turning left ) ; \\ ( 1 - \frac{W tan θ}{2 L} ) {V}_{RR} , & θ < 0 ( turning right ) .\end{matrix}$$

$${V}_{3} ≃ \{ \begin{matrix}( cos θ + \frac{W sin θ}{2 L} ) {V}_{FL} , & θ \geq 0 ( turning left ) ; \\ ( cos θ - \frac{W sin θ}{4 L + 4 W sin θ} ) {V}_{FL} , & θ < 0 ( turning right ) .\end{matrix}$$

$${V}_{4} ≃ \{ \begin{matrix}( cos θ + \frac{W sin 2 θ}{4 L - 4 W sin θ} ) {V}_{FR} , & θ \geq 0 ( turning left ) ; \\ ( cos θ + \frac{W sin θ}{2 L} ) {V}_{FR} , & θ < 0 ( turning right ) .\end{matrix}$$

In Equation 2, θ is the average angle of the front right and front left wheels, W is the width of the vehicle, and L is the wheelbase of the vehicle. These equations will change if the vehicle is equipped with rear steering system.

FIG. 2b illustrates the exemplary modules of the first subsystem 200, according to an embodiment of the disclosure. The first subsystem 200 can include a wheel linear speed calculation module 220 configured to receive the rotating wheel speed and tire radius of each wheel and calculate the linear speed of each wheel by multiplying the rotating wheel speeds by tire radii. The first subsystem can also include a compensated linear speed calculation module 222 configured to calculate a compensated linear speed measured from each wheel based on the average angle of the front right and front left wheels, the width of the vehicle, and the wheelbase of the vehicle.

### Second Subsystem 104

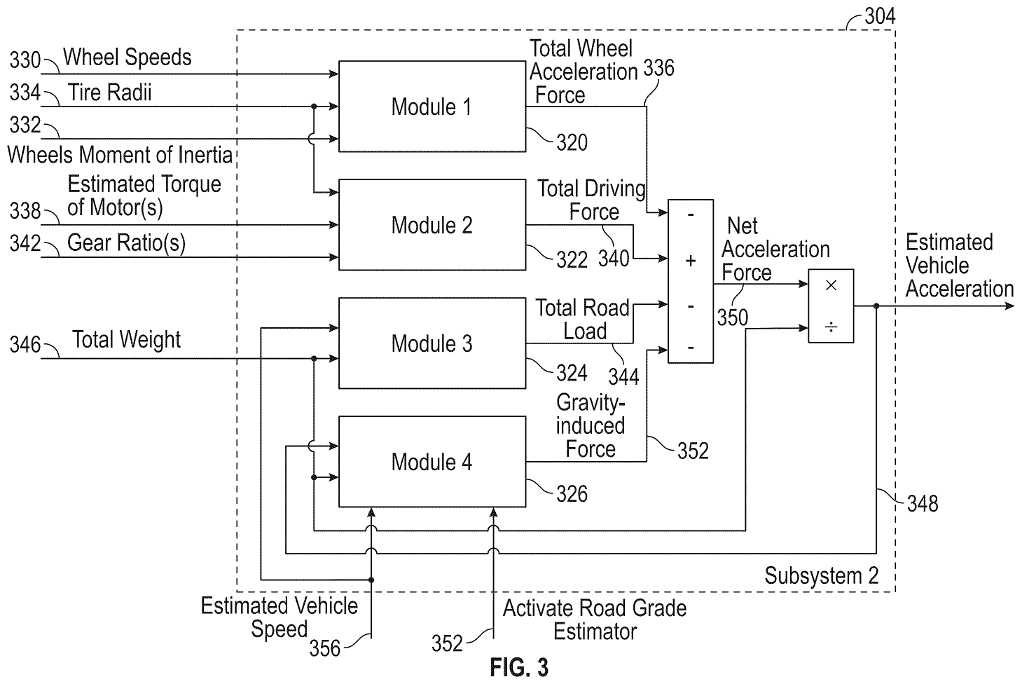

Referring back to FIG. 1, the second subsystem 104 calculates the total driving force produced by the motor(s), removes the following terms from it: (a) total wheel acceleration force (i.e., the total force used by the wheels to accelerate), (b) total road load, and (c) gravity-induced force, and outputs the estimated vehicle acceleration 110. In one embodiment, as illustrated in FIG. 3, the second subsystem 304 can include four modules 320, 322, 324, 326, each of which will be discussed in detail in the paragraphs below.

First module 320 can calculate the total torque and force used to increase the rotating speed of the wheels. In this embodiment, first module 320 uses the speeds 330, moments of inertia 332, and radii 334 of the wheels for this calculation. First module 320 can calculate the total wheel acceleration force 336 using Equation 3 below.

$$Total Wheel Acceleration Force = {\sum }_{i = 1}^{4} \frac{{J}_{i}}{{r}_{i}} ( \frac{d {ω}_{i}}{dt} ) . \qquad ( Equation 3 )$$

In Equation 3, ωᵢ is the rotating speed of wheel i, rᵢ is the radius of the tire of wheel i, and jᵢ is the moment of inertia of wheel i.

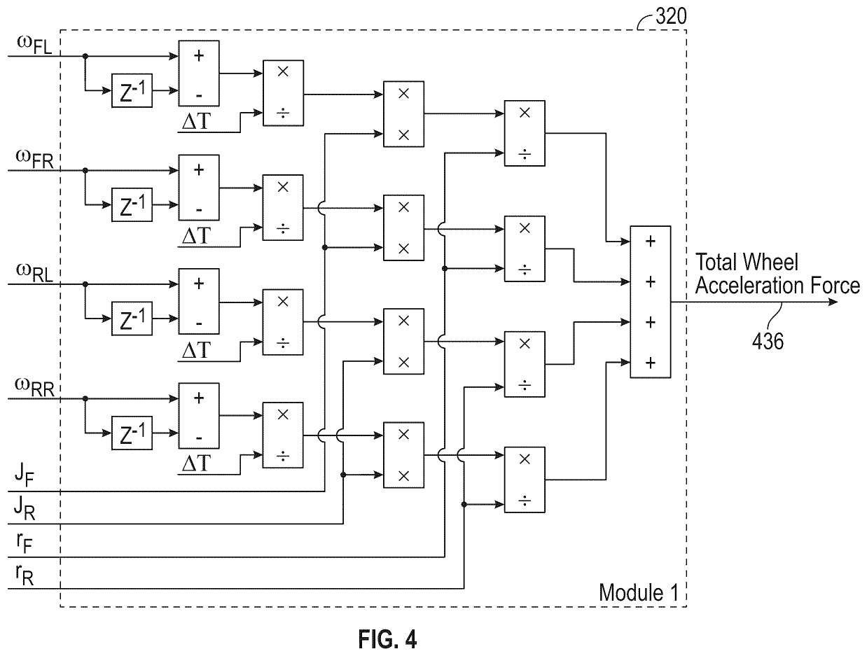

FIG. 4 illustrates the exemplary operations (e.g., multiplication, summation, subtraction) of first module 320 of FIG. 3. First module 320 receives inputs including the rotating speeds of the 4 wheels ω_{FL}, ω_{FR}, ω_{RL}, ω_{RR}, the radius of the front wheels r_{F} and rear wheels r_{R}, and the moments of inertial of the front wheels J_{F} and rear wheels J_{R} and outputs the total wheel acceleration force 436 after performing the operations illustrated in FIG. 4 on these inputs.

Referring back to FIG. 3, second module 322 of second system 304 can calculate the total driving force 340 produced by the traction motor(s). In this embodiment, the calculation is done using the following equation 4:

$$Total Driving Force = {\sum }_{i = 1}^{Number of Motors} \frac{{T}_{i} {G}_{i}}{{r}_{i}} , \qquad ( Equation 4 )$$

where Tᵢ is the torque 338 produced by ith motor, Gᵢ is the gear ratio 342 between ith motor and the associated wheel(s), and rᵢ is the radius of the wheel(s) powered by ith motor. It should be understood that the vehicle can have any number of motors.

Third module 324 of the second subsystem 304 can calculate the total road load 344, which can include tire load and drag load. The former mostly depends on the tire characteristics and total weight of the vehicle (including passengers and cargo) 346, while the latter mostly depends on the drag coefficient and the frontal area of the vehicle. Total road load 344 can be analytically computed. It can also be estimated based on lookup table(s) derived based on coast-down test results at different weights. Both approaches (analytical and test-based) require vehicle weight information 346, which could be estimated by means of a weight estimator. In the absence of a weight estimator, a fixed value representing an average vehicle weight could be used.

Fourth module 326 of the second subsystem 304 receives the estimated vehicle acceleration 348 from the output of the second subsystem 304, compares it with the actual vehicle acceleration computed based on estimated vehicle speed 350, and estimates the road grade 352 based on the difference in the two acceleration values. An “Activate Road Grade Estimator” signal sent by the fourth subsystem (not shown in FIG. 3) enables the road grade estimator of the fourth module 326. Whenever the estimator is disabled, fourth module 326 can use the latest estimate of the road grade.

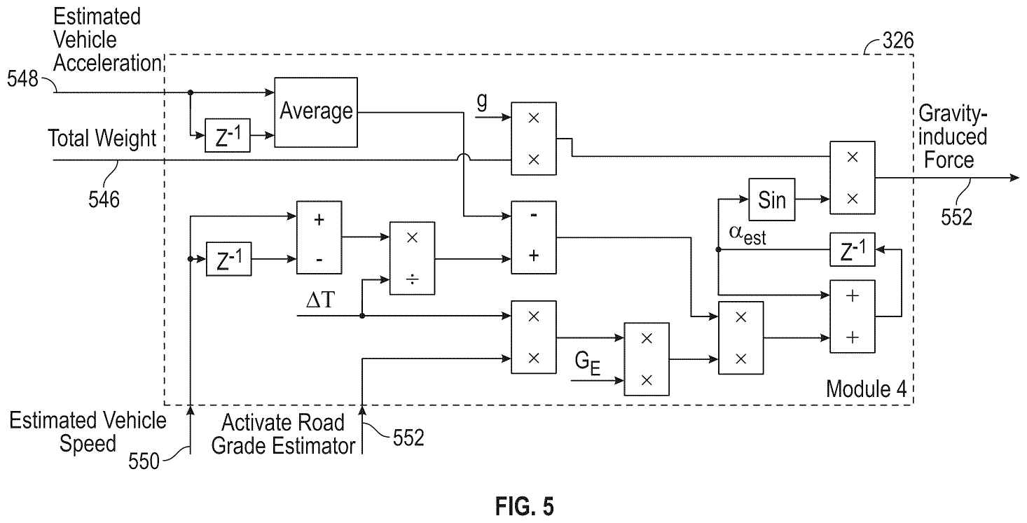

FIG. 5 is a diagram illustrating the operations of fourth module 326 of second subsystem 304, according to an embodiment of the disclosure. In FIG. 5, g is the gravitational acceleration, αₑₛₜ is the estimated road grade, and ΔT is the sampling time of the system. As illustrated, fourth module 326 receives the estimated vehicle acceleration 548, total weight of the vehicle 546, estimated vehicle speed 550, and road grade 552 estimated by the active road grade estimator, and outputs the gravity-induced force 552 by performing the operations illustrated in FIG. 5.

### Third Subsystem 106

Referring again to FIG. 1, third subsystem 106 uses the average vehicle acceleration 110 as estimated by the second subsystem 104 and the vehicle speed from the previous sample 112 to predict the current vehicle speed 114.

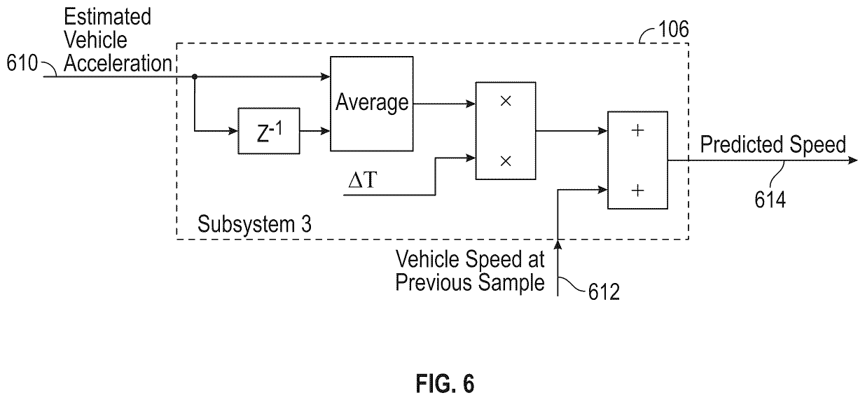

FIG. 6 illustrates the exemplary operations performed by third subsystem 106 of FIG. 1, where ΔT is the sampling time of the system. Third subsystem 106 can output a predicted speed of the vehicle 614 from an estimated vehicle acceleration 610 and a vehicle speed at previous sample 612 by performing the operations of FIG. 6.

### Fourth Subsystem 108

Referring again to FIG. 1, fourth subsystem 108 evaluates the compensated speed of each wheel 116 and decides if it should be included in the final vehicle speed calculation. For validation, an acceptable range is defined for compensated wheel speeds as [Predicted Vehicle Speed−ΔV₁, Predicted Vehicle Speed+ΔV₂], where ΔV₁ and ΔV₂ are design parameters. Any compensated wheel speed 116 that is within this range is considered valid and is included in the final averaging function to find the vehicle speed. Any compensated wheel speed 116 that is not within this range is considered invalid and is replaced with the predicted vehicle speed 114 output by the third subsystem 106.

Fourth subsystem can override range check of wheel speeds and consider all wheel speed readings as valid if the powertrain controller detects a friction brake status 128 that indicates the friction brakes (either service brakes and/or parking brake) are engaged (either by the driver's press of brake pedal or by electronic stability program). The reason is that it is assumed that the brake controller may not have a good estimate of the total brake torque applied to friction brakes and the system cannot rely on its estimated torque for estimation purpose.

Fourth subsystem 108 takes the average of the final four values (each being a compensated wheel speed 116 or predicted vehicle speed 114) to estimate the vehicle speed 120.

Fourth subsystem 108 also decides whether the load grade estimator should be activated. In one embodiment, it can activate the estimator by sending an “Activate Road Grate Estimator” signal 118 to the second subsystem 104 if all compensated wheel speeds 116 are valid and friction brakes are not engaged.

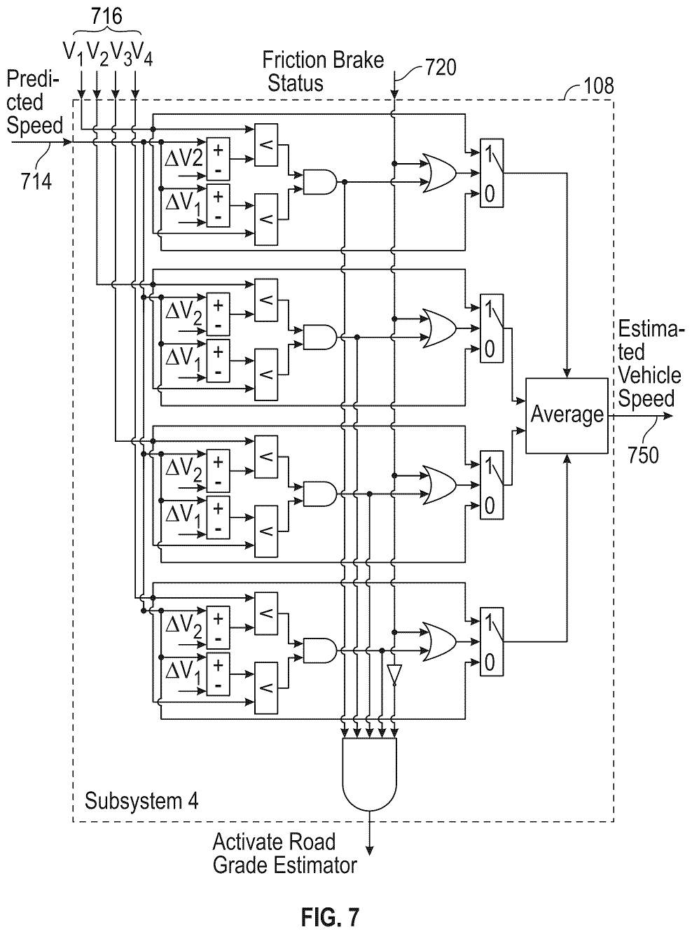

FIG. 7 illustrates the exemplary operations of fourth subsystem 108 of FIG. 1, according to an embodiment of the disclosure. The fourth subsystem 108 receives the compensated wheel speed of each wheel (collectively 716) from first subsystem 102 of FIG. 1 (not shown in FIG. 7), predicted speed 714 from third subsystem 106 of FIG. 1 (not shown in FIG. 7), and friction brake status 720 from the brake controller or power controller of the vehicle. Through performing the operations shown in FIG. 7, fourth system can output an estimated vehicle speed 750 based on either the average compensated wheel speed or the predicted wheel speed given that the friction brake(s) status indicates that the friction brake(s) are not engaged.

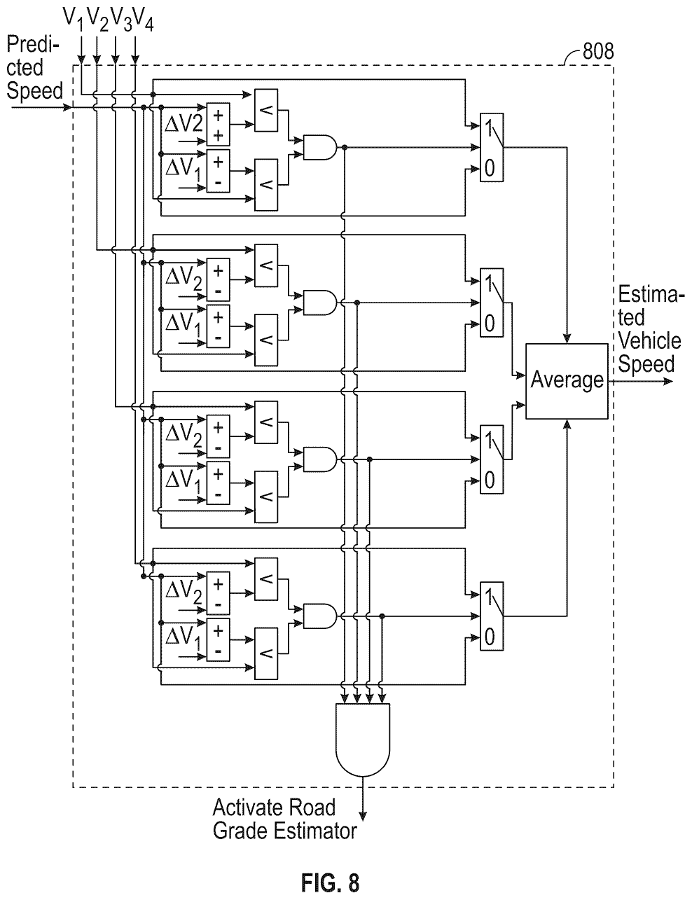

FIG. 8 illustrates an alternative embodiment to the operations of the fourth subsystem. In this alternative embodiment, an achieved friction brake torque reported by the brake controller is accurate enough to be included for speed estimation. Specifically, the fourth subsystem 808 of FIG. 8 uses friction brake achieved torque values instead of the friction brake status 750 of FIG. 7.

In this alternative embodiment, second subsystem can include an additional module (not shown in FIG. 3) and the output of this additional module of second subsystem 104 should be subtracted from the estimated net accelerating force 350. This new subsystem can calculate total friction brake force as:

$${F}_{B , Total} = {\sum }_{i = 1}^{4} \frac{{T}_{B , i}}{{r}_{i}} . \qquad ( Equation 5 )$$

All of the methods and tasks described herein may be performed and fully automated by one or more computer systems. Each such computing system can include a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A system for estimating a speed of a vehicle comprising a plurality of wheels, the system comprising:
a first subsystem configured to receive a steering angle, dimensions of the vehicle, wheel speeds and tire radii of the plurality of wheels and determine compensated wheel speeds of the plurality of wheels;
a second subsystem configured to receive moment of inertia of the plurality of wheels, estimated torque of one or more motors of the vehicle, a weight of the vehicle, the wheel speeds and tire radii of the plurality of wheels, and output an estimated vehicle acceleration;
a third subsystem in communication with the second subsystem and configured to receive the estimated vehicle acceleration from the second subsystem, the third subsystem further configured to predict a current speed of the vehicle based on the estimated vehicle acceleration and a previous vehicle speed; and
a fourth subsystem in communication with the first subsystem, the second subsystem, and the third subsystem, the fourth subsystem configured to estimate the speed of the vehicle based on either the compensated wheel speeds or the predicted vehicle speed.

2. The system of claim 1, wherein the first subsystem is configured to determine compensated wheel speeds of the plurality of wheels by multiplying a rotating speed of each of the plurality of wheels by the tire radius of the wheel to calculate a linear speed of each wheel and determine the compensated wheel speeds based on the linear speeds of the plurality of wheels, an average angle of two of the plurality of wheels, a width of the vehicle, and a wheelbase of the vehicle.

3. The system of claim 1, wherein the second subsystem is further configured to calculate a total driving force produced by the one or more motors, remove from the total driving force a total wheel acceleration force, a total road load, and a gravity-induced force to output the estimated vehicle acceleration.

4. The system of claim 1, wherein the second subsystem comprises:
a first module configured to calculate a total torque and force used to increase a rotating speed of the plurality of wheels;
a second module configured to calculate the total driving force produced by the one or more motors;
a third module configured to calculate a total road load;
a fourth module configured to receive the estimated vehicle acceleration from the second subsystem, compare it with an actual vehicle acceleration computed based on estimated vehicle speed, and estimate a road grade based on a difference between the estimated vehicle acceleration and the actual vehicle acceleration.

5. The system of claim 4, wherein the total road load comprises a tire load and a drag load.

6. The system of claim 4, wherein the first module is configured to calculate the total torque and force based on the wheel speeds, moments of inertia, and radii of the wheels.

7. The system of claim 4, wherein the fourth module is configured to estimate the road grade in response to receiving a signal from the fourth subsystem.

8. The system of claim 7, wherein the fourth module is configured to use the latest estimate of the road grade as the road grade in the absence of the signal from the fourth subsystem.

9. The system of claim 1, wherein the third subsystem is configured to use an average acceleration since last step as estimated by the second subsystem and a vehicle speed in the last step to predict a current vehicle speed.

10. The system of claim 1, wherein the fourth subsystem is configured to evaluate a speed of each wheel and determine if the speed of each wheel should be included in a calculation of the vehicle speed.

11. The system of claim 10, wherein the fourth subsystem is configured to override a range check of wheel speeds and consider all wheel speed readings as valid if friction brakes are detected to be engaged.

12. The system of claim 11, wherein the friction brakes are detected to be engaged either by a driver's press of the brake pedal or by an electronic stability program.

13. The system of claim 10, wherein the fourth subsystem includes in the calculation of vehicle speed an achieved friction brake torque reported if the achieved friction brake torque is accurate.

14. A method of estimating a speed of a vehicle comprising a plurality of wheels, the method comprising:
receiving a steering angle, dimensions of the vehicle, wheel speeds and tire radii of the plurality of wheels and determining compensated wheel speeds of the plurality of wheels;
receiving moment of inertia of the plurality of wheels, estimated torque of one or more motors of the vehicle, a weight of the vehicle, the wheel speeds and tire radii of the plurality of wheels, and outputting an estimated vehicle acceleration;
predicting a current speed of the vehicle based on the estimated vehicle acceleration and a previous vehicle speed; and
estimating the speed of the vehicle based on either the compensated wheel speeds or the predicted vehicle speed.

15. The method of claim 14, further comprising:
determining compensated wheel speeds of the plurality of wheels by multiplying a rotating speed of each of the plurality of wheels by the tire radius of the wheel to calculate a linear speed of each wheel; and
determining the compensated wheel speeds based on the linear speeds of the plurality of wheels, an average angle of two of the plurality of wheels, a width of the vehicle, and a wheelbase of the vehicle.

16. The method of claim 14, further comprising calculating a total driving force produced by the one or more motors; and
removing from the total driving force a total wheel acceleration force, a total road load, and a gravity-induced force to output the estimated vehicle acceleration.

17. The method of claim 14, further comprising:
calculating a total torque and force used to increase a rotating speed of the plurality of wheels;
calculating the total driving force produced by the one or more motors;
calculating a total road load;
comparing the estimated vehicle acceleration with an actual vehicle acceleration computed based on estimated vehicle speed; and
estimating a road grade based on a difference between the estimated vehicle acceleration and the actual vehicle acceleration.

18. The method of claim 14, further comprising calculating the total torque and force based on the wheel speeds, moments of inertia, and radii of the wheels.

19. The method of claim 14, further comprising evaluating a speed of each wheel and determining if the speed of each wheel should be included in a calculation of the vehicle speed; and
overriding a range check of wheel speeds and considering all wheel speed readings as valid if friction brakes are detected to be engaged.

20. A non-transitory computer-readable storage medium storing instructions for causing a processor to perform a method of estimating a speed of a vehicle comprising a plurality of wheels, the method comprising:
receiving a steering angle, dimensions of the vehicle, wheel speeds and tire radii of the plurality of wheels and determining compensated wheel speeds of the plurality of wheels;
receiving moment of inertia of the plurality of wheels, estimated torque of one or more motors of the vehicle, a weight of the vehicle, the wheel speeds and tire radii of the plurality of wheels, and outputting an estimated vehicle acceleration;
predicting a current speed of the vehicle based on the estimated vehicle acceleration and a previous vehicle speed; and
estimating the speed of the vehicle based on either the compensated wheel speeds or the predicted vehicle speed.
